(19) United States
(12) Patent Application Publication
(10) Pub. No.: US 2012/0328082 A1
(43) Pub. Date: Dec. 27, 2012

(54) X-RAY MIRROR, METHOD OF PRODUCING THE MIRROR, AND X-RAY APPARATUS

(75) Inventors: Wataru Kubo, Inagi-shi (JP); Kohei Okamoto, Yokohama-shi (JP); Atsushi Komoto, Moriya-shi (JP); Hirokatsu Miyata, Hadano-shi (JP)

(73) Assignee: CANON KABUSHIKI KAISHA, Tokyo (JP)

(21) Appl. No.: 13/582,578

(22) PCT Filed: Jun. 1, 2010
(86) PCT No.: PCT/JP2011/062559

§ 371 Date: Sep. 4, 2012

(30) Foreign Application Priority Data
Jun. 1, 2010 (JP) 2010-126325

(51) Int. Cl. G21K 1/06; B05D 5/00

(52) U.S. Cl. 378/145; 427/160

(57) ABSTRACT

Provided is an X-ray mirror, a method of producing the X-rat mirror, and an X-ray apparatus. The X-ray mirror comprises: a substrate; and an X-ray reflecting structure formed of multiple regions present on the substrate, in which the X-ray reflecting structure comprises a mesostructured film that has the multiple regions having different structural periods in a normal direction of the substrate. Thus, there can be reduced the absorption loss of an X-ray of the mirror that reflects X-rays having different energies.

### TECHNICAL FIELD

The present invention relates to an X-ray mirror using a mesostructured material, a method of producing the mirror, and an X-ray apparatus having, as a part of its X-ray optical path, an X-ray mirror using a mesostructured material.

### BACKGROUND ART

An X-ray has been widely utilized in the fields of, for example, medicine, non-destructive inspection, and crystallography. Total reflection and Bragg diffraction have been typically used for the reflection of the X-ray. A multilayer mirror as a reflecting mirror that utilizes the Bragg diffraction can correspond to an X-ray having a high energy practically as compared with a mirror that utilizes the total reflection.

On the other hand, it is difficult to obtain reflection over a wide energy region of X-rays because the reflection of the X-rays is specified by a Bragg condition. A mirror in which multilayer films having different periods are laminated (so-called super mirror) has been developed for solving the difficulty. In the multilayer mirror obtained by the lamination, an X-ray having a long wavelength is reflected at a multilayer film having a large period, and an X-ray having a short wavelength is reflected at a multilayer film having a small period. As a result, X-rays covering a wide energy region can be reflected.

Japanese Patent Application Laid-Open No. 2003-255089 discloses a technology related to a mirror in which multiple multilayer films having different periods are laminated.

Silicon generally used in a multilayer film has been used in a light element layer (spacer layer) of a multilayer film given in Japanese Patent Application Laid-Open No. 2003-255089. Such material for the light element layer has an ability to absorb an X-ray that cannot be neglected, which is responsible for a reduction in the reflectance of the mirror. In particular, in the case of a mirror in which multiple multilayer films are laminated, the optical path length of an X-ray that passes the inside of the mirror often lengthens, and hence the absorption loss enlarges. Accordingly, an additional improvement of the mirror has been requested.

### CITATION LIST

### Patent Literature

TL 1: Japanese Patent Application Laid-Open No. 2003-255089

### SUMMARY OF INVENTION

### Technical Problem

The present invention has been made in view of such background art, and provides an X-ray mirror showing a small absorption loss of an X-ray and capable of reflecting X-rays having different energies, a method of producing the mirror, and an X-ray apparatus having the X-ray mirror as a part of its X-ray optical path.

### Solution to Problem

An X-ray mirror for solving the above-mentioned problem comprises: a substrate; and an X-ray reflecting structure formed of multiple regions present on the substrate, in which the X-ray reflecting structure comprises a mesostructured film that has the multiple regions having different structural periods in a normal direction of the substrate.

A method of producing an X-ray mirror for solving the above-mentioned problem is a method of producing an X-ray mirror including a substrate and an X-ray reflecting structure formed of multiple regions present on the substrate, the method comprising, as formation of the X-ray reflecting structure, at least: forming a first mesostructured film having a periodic structure on the substrate; and forming, on the first mesostructured film, a second mesostructured film having a periodic structure different from the first mesostructured film in structural period.

Further features of the present invention will become apparent from the following description of exemplary embodiments with reference to the attached drawings.

### BRIEF DESCRIPTION OF DRAWINGS

FIG. 1 is a conceptual view illustrating an embodiment of an X-ray mirror according to the present invention.

FIG. 2 is a graph illustrating the dependence of the X-ray transmittance of a material used in a light element layer or in a pore or organic compound site of a mesostructured film (axis of ordinate) on an energy (axis of abscissa).

FIG. 3 is a graph illustrating the dependence of the reflectance of each of X-ray mirrors of an example of the present invention and a comparative example (axis of ordinate) on the energy of an X-ray (axis of abscissa).

FIG. 4 is a graph illustrating the dependence of the reflectance of each of the X-ray mirrors of the example of the present invention and the comparative example (axis of ordinate) on the incidence angle of an X-ray (axis of abscissa).

FIG. 5 is a graph illustrating the dependence of the reflectance of each of the X-ray mirrors of the example of the present invention and the comparative example (axis of ordinate) on the energy of an X-ray (axis of abscissa).

FIG. 6 is a graph illustrating the dependence of the reflectance of each of the X-ray mirrors of the example of the present invention and the comparative example (axis of ordinate) on the energy of an X-ray (axis of abscissa).

FIG. 7 is a graph illustrating the dependence of the peak value of the reflectance of each of the X-ray mirrors of the example of the present invention and the comparative example (axis of ordinate) on a ratio (thickness) of pores or organic compound sites to a mesostructured film (axis of abscissa).

FIG. 8 is a schematic view illustrating an example of a fluorescent X-ray apparatus having the X-ray mirror of the present invention as a part of its X-ray optical path.

### DESCRIPTION OF EMBODIMENTS

X-Ray Mirror of the Present Invention)

An X-ray mirror according to the present invention comprises: a substrate; and an X-ray reflecting structure formed of multiple regions present on the substrate, in which the X-ray reflecting structure comprises a mesostructured film that has the multiple regions having different structural periods in a normal direction of the substrate.

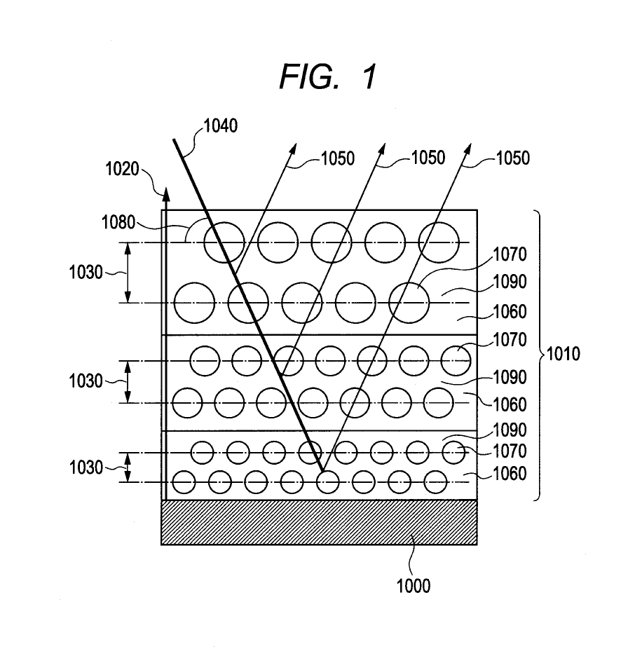

FIG. 1 is a conceptual view illustrating an embodiment of the X-ray mirror according to the present invention. In FIG. 1, reference numeral 1000 represents a substrate, reference numeral 1010 represents a mesostructured film which is formed on the substrate and has multiple regions having different structural periods in the normal direction of a substrate surface, reference numeral 1020 represents the normal direction of the substrate surface, and reference numeral 1030 represents a structural period. In addition, reference numeral 1040 represents an incident X-ray and reference numeral 1050 represents a reflected X-ray. Here, reference numeral 1060 represents a wall portion of the mesostructured film, reference numeral 1070 represents a pore or organic compound site of the mesostructured film, and reference numeral 1080 represents the incidence angle of the X-ray. Reference numeral 1090 represents each of the multiple regions having different structural periods of the mesostructured film.

In the present invention, the X-ray mirror that reflects X-rays having different energies is formed by using the mesostructured film which is formed on the substrate and has the multiple regions having different structural periods in the normal direction of the substrate surface.

Next, the X-ray mirror according to this embodiment is described below with regard to three items, i.e., (1) the substrate, (2) the mesostructured film that has the multiple regions having different structural periods in the normal direction of the substrate surface, and (3) an effect of the mirror.

(1) Substrate

Any material can be used without any particular limitation in the substrate used in the present invention as long as the material enables the formation of the mesostructured film. Examples of the material include silicon, quartz, glass, and a metal. Any shape can be selected without any particular limitation for the substrate as long as the shape satisfies a characteristic needed for the mirror. Examples of the shape include a flat surface shape and a curved surface shape.

(2) Mesostructured Film that has Multiple Regions Having Different Structural Periods in Normal Direction of Substrate Surface

(2-1) Mesostructured Film

Porous materials are classified by the International Union of Pure and Applied Chemistry (IUPAC) depending on their pore diameters, and a porous material having a pore diameter of 2 to 50 nm is classified as being mesoporous. Researches have been vigorously conducted on the mesoporous material in recent years, and as a result, a structure in which meso pores having a uniform diameter are regularly arranged can be obtained by using an assembly of a surfactant as a template.

Here, the term “mesostructured film” as used in the present invention refers to (A) a mesoporous film and (B) a mesoporous film whose pores are mainly filled with an organic compound.

Such mesostructured film is a material having a relatively low ability to absorb an X-ray such as an air pore or the organic compound as compared with a conventional material having a relatively high ability to absorb an X-ray such as silicon or carbon. Therefore, the X-ray mirror of the present invention using the mesostructured film shows a reduced absorption loss as compared with that of a conventional X-ray mirror.

Detailed description is given below.

(A) Mesoporous Film

The mesoporous film is a porous material having a pore diameter of 2 to 50 nm, and a material for a wall portion, which is not particularly limited, is, for example, an inorganic oxide from the viewpoints of production possibility and a characteristic as the X-ray mirror. Examples of the inorganic oxide include silicon oxide, tin oxide, zirconium oxide, titanium oxide, niobium oxide, tantalum oxide, aluminum oxide, tungsten oxide, hafnium oxide, and zinc oxide. A surface of the wall portion may be modified as necessary. For example, the surface of the wall portion may be modified by a hydrophobic molecule for inhibiting the adsorption of water.

Although a method of preparing the mesoporous film is not particularly limited, the film can be prepared by, for example, the following method. A precursor for the inorganic oxide is added to a solution of an amphipathic substance whose assembly functions as a template. Then, film formation is performed so that a reaction for producing the inorganic oxide may be advanced. After that, template molecules are removed so that the porous material may be obtained.

The amphipathic substance, which is not particularly limited, is suitably a surfactant. Examples of the surfactant molecule include ionic and nonionic surfactants. The ionic surfactant is, for example, a halide salt of a trimethylalkylammonium ion. The chain length of the alkyl chain is, for example, 10 to 22 in terms of a carbon number. Examples of the nonionic surfactant include surfactants each containing polyethylene glycol as a hydrophilic group. Specific examples of the surfactants each containing polyethylene glycol as a hydrophilic group include a polyethylene glycol alkyl ether and a polyethylene glycol-polypropylene glycol-polyethylene glycol block copolymer. The chain length of the alkyl chain of the polyethylene glycol alkyl ether is, for example, 10 to 22 in terms of a carbon number, and the number of repetitions of the polyethylene glycol is, for example, 2 to 50. A mesopore diameter can be changed by changing the hydrophobic group or hydrophilic group. In general, a pore diameter can be extended by making a hydrophobic group or hydrophilic group large. In addition, an additive for adjusting a micelle diameter as well as the surfactant may be added. The additive for adjusting a micelle diameter is, for example, a hydrophobic substance. Examples of the hydrophobic substance include alkanes and aromatic compounds free of hydrophilic groups. The hydrophobic substance is specifically, for example, octane.

Examples of the precursor for the inorganic oxide include an alkoxide of silicon or a metal element and a chloride. More specific examples thereof include an alkoxide of Si, Sn, Zr, Ti, Nb, Ta, Al, W, Hf, or Zn and a chloride. Examples of the alkoxide include a methoxide, an ethoxide, a propoxide, and an alkoxide partly substituted with an alkyl group.

Examples of the film-forming method include a dip coating method, a spin coating method, and a hydrothermal synthesis method. Examples of the method of removing the template molecules include calcination, extraction, ultraviolet irradiation, and ozonation.

(B) Mesoporous Film Whose Pores are Mainly Filled With Organic Compound

Any one of the same materials as those described in the section for the mesoporous film (A) can be used as a material for a wall portion. The substance with which each pore is filled is not particularly limited as long as the substance is mainly formed of an organic compound. The term “mainly” means that a volume ratio of the organic compound to the substance is 50% or more. The organic compound is, for example, a surfactant or a material in which a site having a function of forming a molecular assembly is bonded to the material forming a wall portion or a precursor for the material forming the wall portion. Examples of the surfactant include the surfactants described in the section (A). In addition, examples of the material in which the site having a function of forming a molecular assembly is bonded to the material forming the wall portion or the precursor for the material forming the wall portion include an alkoxysilane having an alkyl group and an oligosiloxane compound having an alkyl group. The chain length of the alkyl chain is, for example, 10 to 22 in terms of a carbon number.

The inside of each pore may contain water, an organic solvent, a salt, or the like as required, or as a result of a material to be used or a step. Examples of the organic solvent include an alcohol, an ether, and a hydrocarbon.

A method of preparing the mesoporous film whose pores are mainly filled with the organic compound, which is not particularly limited, is, for example, a step before the template removal of the method of preparing the mesoporous film described in the section (A).

(2-2) Mesostructured Film Having Periodic Structures in Normal Direction of Substrate Surface

The mesostructured film in the present invention has periodic structures in the normal direction of the substrate surface. The term “normal direction of the substrate surface” refers to the normal direction of the flat surface of the substrate when the substrate is a flat substrate or to the normal direction of a tangential plane of a curved substrate when the substrate is the curved substrate. The range of the structural periods is, for example, the range of 2 nm to 50 nm. The expression “having periodic structures in the normal direction” means that an actual periodic structures are present in a direction at an angle of 10° or less, preferably 3° or less, more preferably 1° or less from the normal direction. Mesostructured films having various periodic structures ranging from one-dimensional to three-dimensional structures have been generally known.

A mesostructured film having periodic structures in the normal direction of the substrate surface can be used as the mesostructured film as a component of the X-ray mirror of the present invention. The description does not eliminate the possibility that the mesostructured film has a periodic structure in a direction except the normal direction of the substrate surface. The structure of the mesostructured film is, for example, a lamellar structure, a two-dimensional hexagonal structure, a three-dimensional hexagonal structure, a three-dimensional cubic structure, or a structure obtained by the deformation of any one of the structures. The deformation is, for example, a structure obtained by the contraction of any one of the above-mentioned structures in a thickness direction.

The mesostructured film has the multiple regions having different structural periods in the normal direction of the substrate. The term “multiple regions” as used herein refers to regions each having a periodic structure, and the periods of the periodic structures of the respective regions (that is, the “structural periods” which may hereinafter be simply referred to as “periods”) differ from each other from region to region. The following two points concerning the mesostructured film having multiple periodic structures whose periods differ from region to region (that is, the mesostructured film that has the multiple regions having different structural periods) are important parameters that affect the characteristics of the X-ray mirror:

(a) the number of periods (number of repetitions) of a certain structural period (region); and
(b) a ratio (thickness) of pores or organic compound sites to the mesostructured film.

The ranges of those values are, for example, the following values. A lower limit for (a) the number of periods is 2 as a minimum value for a multilayer film. An upper limit for the number of periods, which is specified by a thickness that can be produced, is practically about 5,000, more practically 4 or more and 5,000 or less, still more practically 4 or more and 500 or less. A value for (b) the volume ratio of the pores or the organic compound sites to the entire mesostructured film is 0.012 or more and 0.997 or less so that the resultant may function as an X-ray mirror.

Whether or not the structures are formed can be confirmed by X-ray diffraction analysis or observation with an electron microscope. Specifically, the fact that the mesostructured film has periodic structures in the normal direction of the substrate surface and the periods of the structures can be confirmed by X-ray diffraction analysis in a Bragg-Brentano geometry. Further, the periodic structures can each be confirmed as an image by the observation of a film section with a transmission electron microscope or with a scanning electron microscope. In addition, in the case of a porous material, its pore diameter distribution and pore diameter range can be determined from the results of the measurement of a nitrogen gas adsorption isotherm by a Barret-Joyner-Halenda (BJH) method.

(2-3) Mesostructured Film that has Multiple Regions Having Different Structural Periods

The mesostructured film used in the present invention is a mesostructured film that has multiple regions having different structural periods in the normal direction of the substrate surface. The multiple regions are preferably three or more regions. Although it is basically assumed that the structural periods change in a stepwise fashion, the structural periods may continuously change depending on requested characteristics.

It is preferred that: the multiple regions having the different structural periods each comprises a layer; and the structural periods of the respective layers are different from each other.

The X-ray mirror of the present invention reflects an X-ray mainly by Bragg diffraction. A condition for the Bragg diffraction is given by the following formula (1):

nλ=2d sinθ (1)

(n: an order, λ: the wavelength of an incident X-ray, d: a structural period, θ: an incidence angle).

Accordingly, in the X-ray mirror of the present invention, in the case where the incidence angle is constant, the range of the wavelengths of X-rays corresponding to the Bragg diffraction widens as the number of the regions increases. In addition, when it is assumed that the wavelength is constant, such an effect that the range of incidence angles corresponding to the Bragg diffraction widens as the number of the regions increases arises. On the other hand, an increase in the number of the regions involves the emergence of such problems that production steps become complicated and a cost increases in association with the complication. In view of the foregoing, the number of the regions is set depending on an application of the mirror.

(2-4) Order in Which Multiple Regions are Placed

The multiple regions having the different structural periods of the mesostructured film in the present invention are preferably such that a structural period enlarges as the structural period is closer to a plane on which an X-ray is incident (in other words, more distant from the substrate). The foregoing can be described as follows. The transmitting ability of an X-ray raises as its energy increases. Accordingly, the following order is advantageous in consideration of entire reflection efficiency. In the mesostructured film, an X-ray having a high energy whose transmitting ability is high is reflected at a position distant from the incidence plane, and an X-ray having a low energy whose transmitting ability is low is reflected at a position near the incidence plane. As can be understood from the formula (1), a structural period and a wavelength are proportional to each other. Accordingly, an X-ray having a high energy, i.e., an X-ray having a short wavelength corresponds to a small period while an X-ray having a low energy, i.e., an X-ray having a long wavelength corresponds to a large period. Therefore, the order in which the multiple regions of the mesostructured film of the present invention are placed is preferably such that a period enlarges as the period is closer to the plane on which an X-ray is incident.

(3) Effect

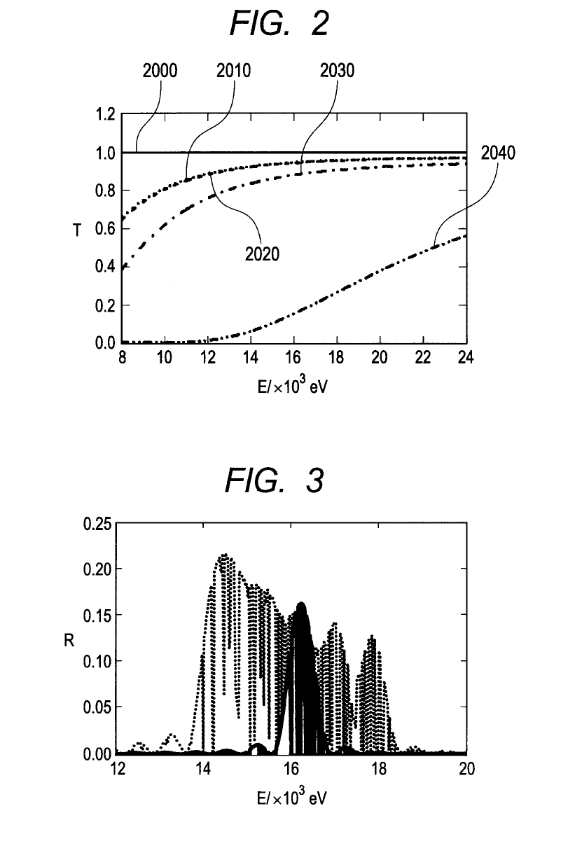

In a conventional multilayer film, silicon or carbon (graphite) has been generally used as a material for a light element layer. The ability of such material for the light element layer to absorb an X-ray is too high to be neglected, and is responsible for a reduction in the reflectance of a mirror. In the mesostructured film of the present invention, an air pore or an organic compound is used so as to correspond to the light element layer. As a result, the loss of the X-ray due to the absorption can be reduced, and hence the reflectance of the mirror can be increased. FIG. 2 illustrates an example of the effect of the absorption. FIG. 2 is a graph illustrating the dependence of the X-ray transmittance of a material used in the light element layer or in a pore or organic compound site of the mesostructured film when the thickness of the material is set to 1 mm (axis of ordinate) on an energy (axis of abscissa). In the figure, reference numeral 2000 represents an air pore (nitrogen), reference numeral 2010 represents a polyoxyethylene alkyl ether as a surfactant, reference numeral 2020 illustrated so as to substantially overlap reference numeral 2010 represents a block-poly(ethylene glycol) (20)-a block-poly(propylene glycol) (70)-a block-poly(ethylene glycol) (20) (hereinafter, referred to as “EO (20) PO (70) EO (20)” (where a value in parentheses represents the number of repetitions of each block)) as a surfactant, reference numeral 2030 represents carbon (graphite), and reference numeral 2040 represents silicon. As can be seen from the figure, each pore or organic compound site of the mesostructured film of the present invention shows a high transmittance as compared with that of silicon or carbon (graphite) used in the light element layer of a conventional multilayer film, and hence the absorption loss of an X-ray can be reduced and the reflectance of the mirror can be increased. In addition, a more preferred aspect of the mesostructured film of the present invention is a mesoporous film that absorbs an X-ray to a smaller extent because the film has a pore instead of an organic compound.

(3-1) X-ray Mirror That Reflects X-Rays Having Different Energies

As represented by the formula (1), in the case where it is assumed that an incidence angle is constant, the X-ray mirror of the present invention can be used as an X-ray mirror that reflects X-rays having different energies when the mesostructured film having multiple periodic structures is used in the mirror. Accordingly, the selection of a combination of periods enables, for example, the reflection of X-rays having continuous wavelengths or selective reflection of multiple specific X-rays whose wavelengths largely differ from each other.

(3-2) X-Ray Mirror That Reflects X-Rays Incident at Different Angles

As represented by the formula (1), in the case where the wavelength of an incident X-ray is constant, the X-ray mirror of the present invention can be used as an X-ray mirror that reflects X-rays incident at different angles when the mesostructured film that has multiple regions having different structural periods is used in the mirror. Accordingly, the selection of a combination of periods enables the use of the mirror as, for example, a mirror having a wide allowable range of incidence angles which reflects X-rays in a wide incidence angle range or a mirror that selectively reflects multiple X-rays incident at specific angles that largely differ from each other.

(Method of Producing X-Ray Mirror of the Present Invention)

A method of producing an X-ray mirror according to the present invention is a method of producing an X-ray mirror including a substrate and an X-ray reflecting structure formed of multiple regions present on the substrate, the method comprising, as formation of the X-ray reflecting structure, at least: forming a first mesostructured film having a periodic structure on the substrate; and forming, on the first mesostructured film, a second mesostructured film having a periodic structure different from the first mesostructured film in structural period.

Next, the method of producing an X-ray mirror according to the present invention is described below with regard to (1) the step of preparing the substrate, (2) the step of forming the mesostructured film having a first structural period on the substrate, and (3) the step of forming, on the mesostructured film having the first structural period, the second mesostructured film having a different structural period.

(1) Step of Preparing Substrate

Any one of the materials described in the section (1) of the X-ray mirror of the present invention is used in the substrate to be used in the present invention.

The following procedure is preferably adopted upon use of the substrate. The substrate is sufficiently washed so that a clean surface may be exposed. A method for the washing is, for example, organic solvent washing, water washing, or an acid or UV-ozone treatment.

(2) step of Forming Mesostructured Film Having First Structural Period on Substrate

In order that the step of forming the mesostructured film having the first structural period on the substrate may be described, an example in which an inorganic oxide or a metal is used in the wall portion of the mesostructured film is described with regard to the following steps.

(2-1) Step of Preparing Reaction Solution Containing Precursor Substance for Inorganic Oxide and Amphipathic Substance

(2-2) Step of Bringing Reaction Solution Into Contact With Substrate

(2-3) Step of Forming Mesostructured Film Containing Assembly of Amphipathic Substance in Fine Pores

The mesostructured film is formed on the substrate through the above-mentioned steps. It is because the amphipathic substance undergoes self-assembly to form an assembly (micelle), which serves as a template for pores, that such structure is formed.

Here, the step (2-2) may be performed as substantially the same step as the step (2-3). In addition, a mesoporous film having hollow pores can be formed by further removing the amphipathic substance in the following step as required in addition to the above-mentioned steps.

(2-4) Step of Removing Amphipathic Substance

Here, the step (2-4) may be performed before the step (3) to be described later, or may be collectively performed after the step (3) has been performed.

Hereinafter, those steps are described in detail.

(2-1) Step of Preparing Reaction Solution Containing Precursor Substance for Inorganic Oxide and Amphipathic Substance

The reaction solution contains the precursor for the inorganic oxide, the amphipathic substance, and a solvent. In addition, any other substance may be added as required. Although the sub-steps for forming the step are not particularly limited, for example, the stirring of a mixture obtained by adding, to the solvent, the other substances for forming the reaction solution is performed. Any such sub-step can be performed by controlling, for example, an atmosphere, a temperature, a humidity, and a stirring intensity as required. In addition, sub-steps such as an ultrasonic treatment and filtration can be added as required.

Those listed in the section (2-1) (A) of the first embodiment can be used as the precursor for the inorganic oxide and the amphipathic substance.

Used as the solvent of the reaction solution is one capable of dissolving the precursor for the inorganic oxide and the amphipathic substance. Such solvent is exemplified by water and an alcohol. Examples of the alcohol include ethanol, propanol, methanol, and butanol. Further, two or more kinds of solvents may be used as a mixture.

Any other substance can be added to the reaction solution as required. For example, water is added, which reacts with the precursor for the inorganic oxide to hydrolyze the precursor, thereby finally providing the inorganic oxide. Further, a substance for adjusting the acidity or basicity of the reaction solution may be added. Examples of the substance for adjusting the acidity or basicity include acids such as hydrochloric acid and bases such as ammonium hydroxide. Each of those substances is often added for controlling the rates of the condensation reaction and the hydrolysis of the precursor substance.

(2-2) Step of Bringing Reaction Solution Into Contact With Substrate

Contents to be actually performed of an approach to be employed in the step vary depending on an approach to producing the inorganic oxide. For example, the substrate is immersed in the reaction solution in the case of a hydrothermal synthesis method, or the reaction solution is applied to the substrate in the case of a sol-gel method.

In the step of applying the reaction solution to the substrate, a general application method can be used. Examples of such method include a dip coating method, a casting method, a spin coating method, a spray coating method, an inkjet method, and a pen lithography method.

Of those, the dip coating method is useful as an application method by which a uniform film can be easily formed. An application method based on the dip coating method involves immersing the substrate in the reaction solution and lifting the substrate to apply the solution onto the substrate. The amount in which the solution is applied can be controlled depending on conditions for the application. Representative examples of the conditions include the composition of the solution and the speed at which the substrate is lifted. For example, increasing the amount of the solvent in the reaction solution or reducing the lifting speed generally reduces the application amount (thickness of the film). The application is affected by a surrounding environment. Accordingly, the application can be performed by controlling, for example, an atmosphere, a temperature, a humidity, and the concentration of the solvent in the atmosphere as required.

(2-3) Step of Forming Mesostructured Film Containing Assembly of Amphipathic Substance in Fine Pores

Contents to be actually performed of the step vary depending on the approach to producing the inorganic oxide. For example, the substrate is held while being immersed in the reaction solution in the case of the hydrothermal synthesis method, or the reaction solution applied to the substrate is dried in the case of the sol-gel method.

The step is performed subsequent to the step (2-2). Although both of those steps are separately described, the formation of the mesostructured film is basically considered to begin at the time point when the reaction solution contacts the substrate.

The step in the sol-gel method is specifically, for example, to evaporate the reaction solution (especially the solvent) on the substrate under a controlled environment to produce the inorganic oxide. The step when the dip coating method is employed is, for example, as described below. As the solvent and hydrogen chloride are lost from the solution after the application on the substrate, a reaction between water and the precursor substance for the inorganic oxide progresses, and hence an inorganic oxide film is formed. The items to be controlled of the environment are, for example, a temperature and a humidity. Controlling the temperature condition and the humidity condition results in the control of the rates of the condensation and hydrolysis of the precursor substance, thereby changing the regularity of the arrangement of the assembly of the amphipathic substance. For example, an excessive increase in temperature leads to significant promotion of the condensation reaction, which may inhibit the formation of a uniform thin film. In contrast, an excessively low temperature involves the emergence of the following problem. The rate at which the solvent evaporates is reduced, and hence the formation of the thin film requires a long time. Specifically, for example, the temperature ranges from 0° C. to 50° C., and a relative humidity ranges from 0% to 50%. A holding time as the time period for which the film is held under the temperature and humidity conditions is determined in accordance with the reactivity of the precursor substance to be used, the temperature, and the humidity. The holding time specifically ranges from, for example, 30 minutes to 4 weeks.

The thickness of the porous film obtained through the step, which is not particularly limited, takes a value of, for example, 0.005 μm to 10 μm. In the case of, for example, the dip coating method, a film having a thickness of about 0.05 μm to 3 μm can be formed.

(2-4) Step of Removing Amphipathic Substance

Although a method of removing the amphipathic substance is not particularly limited, methods such as decomposition removal and extraction can each be employed. Examples of the former method include methods based on baking, UV irradiation, and O₃. Examples of the latter method include methods based on a solvent and a supercritical fluid.

In the case of the removal of the amphipathic substance by baking, the amphipathic substance can be removed from the porous film in a substantially complete fashion. A baking temperature and a baking time vary depending on the kind of the amphipathic substance held in the film. Specifically, for example, the temperature ranges from 300° C. to 600° C., and the time ranges from 15 minutes to 24 hours. The employment of a solvent extraction method is of significant importance in terms of the maintenance of the structure at the time of template removal, though it is difficult to remove 100% of the amphipathic substance by the method.

The baking step has the above-mentioned feature. On the other hand, the step may disturb the structural regularity of the mesoporous film to collapse the structure. This is probably because the structure of the inorganic oxide changes owing to a high-temperature environment at the time of the baking. At least one of the reinforcement of the wall of each pore of the mesostructured film and the suppression of the crystal growth of the inorganic oxide is considered to be effective in preventing the change. A method for the foregoing is specifically, for example, a method involving subjecting a precursor for an inorganic oxide such as silicon oxide to a reaction after the formation of the mesostructured film of the inorganic oxide to partially form the inorganic oxide such as silicon oxide. The employment of the method enables one to suppress the disturbance of the structural regularity of the mesostructured film while performing the removal of the surfactant by the baking and the crystallization of the inorganic oxide. The approach can be applied as required at the time of the preparation of the mesoporous film of the inorganic oxide.

(3) Step of Forming, on Mesostructured Film Having First Structural Period, Second Mesostructured Film Having Different Structural Period

The method of producing an X-ray mirror of the present invention is characterized by including the step of further forming, on the first mesostructured film on the substrate, the second mesostructured film having a different structural period. The same step as the method of preparing the first mesostructured film described in the section (2) can be employed as the step of forming the second mesostructured film except that the film is prepared on the first mesostructured film on the substrate. In addition, a pretreatment can be performed prior to the step (3) as required. Examples of the pretreatment include a treatment for stabilizing the first mesostructured film, and a treatment for improving adhesiveness between the first mesostructured film and the second mesostructured film. The former treatment is specifically, for example, to perform a heat treatment after the preparation of the first mesostructured film. The latter treatment is specifically, for example, to perform a surface treatment with UV-O₃ or the like after the preparation of the first mesostructured film.

In addition, in the method of producing an X-ray mirror of the present invention, after the second mesostructured film has been formed, a third mesostructured film is preferably further formed on the second mesostructured film. Further, layers of multiple stages including a fourth layer, a fifth layer, and any subsequent layer may be formed depending on a design in order that target performance may be obtained.

According to a preferred embodiment of the present invention, there can be provided an X-ray mirror showing a small absorption loss of an X-ray and capable of reflecting X-rays having different energies, and a method of producing the mirror.

The X-ray mirror of the present invention can be used as a part of the X-ray optical path (including an X-ray optical path in a light source apparatus) of an apparatus utilizing an X-ray (X-ray apparatus) because the mirror shows a small absorption loss of an X-ray and can reflect X-rays having different energies. Specific examples of such X-ray apparatus include an analyzer and an examination apparatus utilizing X-rays. More specific examples of the apparatus include known X-ray apparatuses including a fluorescent X-ray analyzer, an X-ray diffraction analyzer, and X-ray imaging apparatuses such as an X-ray CT apparatus.

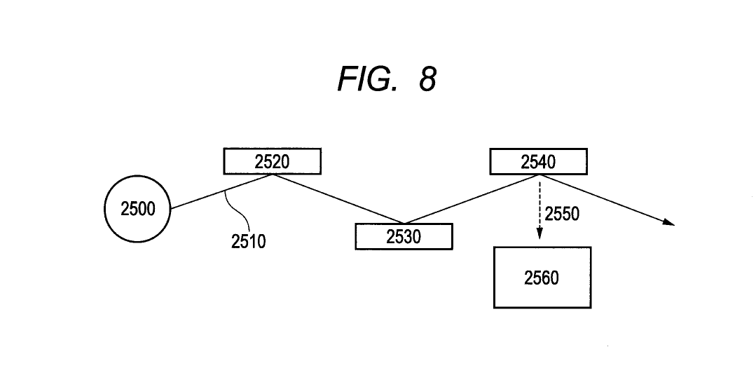

FIG. 8 illustrates a schematic view of a fluorescent X-ray apparatus having the X-ray mirror of the present invention as a part of its X-ray optical path. In the figure, an X-ray emitted from an X-ray source 2500 passes an X-ray optical path 2510, and is then reflected by an X-ray mirror 2520 of the present invention placed in the optical path, subjected to monochrome by an dispersive crystal 2530, and irradiated to a sample 2540. A fluorescent X-ray 2550, emitted from the sample is detected by a detector 2560 and processed as data. The fact that the X-ray apparatus has the X-ray mirror of the present invention as a part of its X-ray optical path means that the X-ray mirror of the present invention is placed at a position in the X-ray apparatus at which the mirror can reflect an X-ray as described above.

### Example 1

Hereinafter, the present invention is described in more detail by way of examples. However, a method of the present invention is not limited only to these examples.

Described in the examples are (1) a function as an X-ray mirror that reflects X-rays having different energies, (2) a function as an X-ray mirror that reflects X-rays having different angles, (3) comparison between the present invention and a conventional X-ray mirror, (4) an effect of the number of regions having different structural periods, (5) an effect of the order in which multiple regions having different structural periods are placed, (6) an effect of a material for forming a wall portion of a mesostructured film, (7) an effect of a ratio (thickness) of pores or organic compound sites to the mesostructured film, and (8) a method of producing an X-ray mirror.

(1) Function as X-ray Mirror That Reflects X-Rays Having Different Energies

In this section, the fact that the X-ray mirror of the present invention has a function of reflecting X-rays having different energies is shown.

FIG. 3 illustrates a calculated value for the dependence of the reflectance of an X-ray mirror formed of a mesostructured film having periodic structures in the normal direction of a substrate surface (axis of ordinate) on the energy of an X-ray (axis of abscissa) under the following conditions.

(Common Conditions)
Wall portion of mesostructured film: Silicon oxide (SiO₂)
Pore or organic compound site of mesostructured film: Air pore (nitrogen)
Incidence angle: 0.5°
Ratio (thickness) of pores or organic compound sites to mesostructured film: 0.7

(the present invention: dotted line)
Number of regions: 5
Structural period: 5.0 nm, 4.8 nm, 4.6 nm, 4.4 nm, 4.2 nm, and 4.0 nm from the side on which an X-ray is incident
Number of periods: 20, 21, 22, 23, 24, and 25 (The order corresponds to the order in which the structural periods are described.)

(comparative example: solid line)
Number of regions: 1
Structural period: 4.4 nm
Number of periods: 23

The figure proves that the X-ray mirror functions as a mirror for X-rays having different energies, in particular, X-rays having continuous energies when the mesostructured film that has multiple regions having different structural periods in the normal direction of the substrate surface is used.

(2) Function as X-Ray Mirror That Reflects X-Rays Having Different Angles

In this section, the fact that the X-ray mirror of the present invention has a function of reflecting X-rays having different angles is shown.

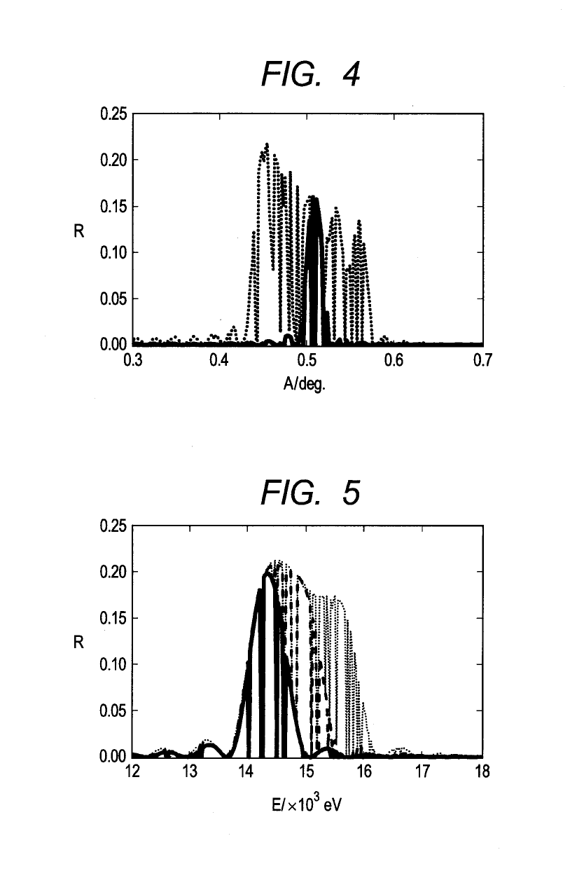

FIG. 4 illustrates a calculated value for the dependence of the reflectance of an X-ray mirror formed of a mesostructured film having periodic structures in the normal direction of a substrate surface (axis of ordinate) on the incidence angle of an X-ray (axis of abscissa) under the same conditions as those of the section (1) (for both of the present invention and the comparative example).

(Common Condition)
Energy of incident X-rays: 16 keV

(the present invention: dotted line, comparative example: solid line)

The figure proves that the X-ray mirror functions as an X-ray mirror that reflects X-rays having different angles with respect to the incident X-rays when the mesostructured film that has multiple regions having different structural periods in the normal direction of the substrate surface is used. In addition, the figure proves that the X-ray mirror functions as an X-ray mirror having a wide allowable range of reflection angles which reflects X-rays in a wide angle range as an example of the foregoing X-ray mirror.

(3) Comparison Between the Present Invention and Conventional X-Ray Mirror

In this section, the superiority of the X-ray mirror of the present invention over a conventional X-ray mirror using a multilayer film is shown.

Table 1 shows the peak value of a reflectance determined when the dependence of the reflectance of an X-ray mirror formed of a mesostructured film that has multiple regions having different structural periods in the normal direction of a substrate surface on the energy of an X-ray is calculated under the following conditions.

(Common Conditions)
Number of regions: 3
Incidence angle: 0.5°
Ratio (thickness) of pores or organic compound sites to mesostructured film: 0.7
Structural period: 5.0 nm, 4.8 nm, and 4.6 nm from the side on which an X-ray is incident
Number of periods: 500 for each region
Energies of incident X-rays: 8 to 24 keV

(the present invention 1)
Wall portion of mesostructured film: Silicon oxide (SiO₂)
Pore or organic compound site of mesostructured film: (nitrogen)

(the present invention 2)
Wall portion of mesostructured film: Silicon oxide (SiO₂)
Pore or organic compound site of mesostructured film: surfactant (polyethylene glycol (10) cetyl ether) (the present invention 3)
Wall portion of mesostructured film: Silicon oxide (SiO₂)
Pore or organic compound site of mesostructured film: Surfactant (EO (20) PO (70) EO (20))

### Comparative Example 1

Heavy element layer: Tungsten

Light element layer: Silicon

### Comparative Example 2

Heavy element layer: Platinum

Light element layer: Carbon (graphite)

TABLE 1

| X-ray mirror | Peak value of reflectance |
|---|---|
| The present invention 1 | 0.9949 |
| The present invention 2 | 0.9857 |
| The present invention 3 | 0.9856 |
| Comparative Example 1 | 0.8362 |
| Comparative Example 2 | 0.8244 |

As can be seen from Table 1, the use of the X-ray mirror of the present invention can reduce the absorption loss of an X-ray of an X-ray mirror that reflects X-rays having different energies, the X-ray mirror having conventionally shown a large absorption loss. The effect appears most significantly in a mesoporous film obtained by turning the pores or organic compound sites of a mesostructured film into air pores (the present invention 1 in the table). In addition, it is shown that even mesostructured films containing surfactants in their pores (the prevent inventions 2 and 3 in the table) each have superiority over the conventional X-ray mirror using a multilayer film.

(4) Effect of Number of Regions Having Different Structural Periods

In this section, an effect of the number of periodic structures having different periods of the X-ray mirror of the present invention is shown.

FIG. 5 illustrates a calculated value for the dependence of the reflectance of an X-ray mirror formed of a mesostructured film having periodic structures in the normal direction of a substrate surface (axis of ordinate) on the energy of an X-ray (axis of abscissa) under the following conditions.

(Common Conditions)
Wall portion of mesostructured film: Silicon oxide (SiO₂)
Pore or organic compound site of mesostructured film: Air pore (nitrogen)
Incidence angle: 0.5°
Ratio (thickness) of pores or organic compound sites to mesostructured film: 0.7

(the present invention 1: thin dotted line)
Number of regions: 3
Structural period: 5.0 nm, 4.8 nm, and 4.6 nm from the side on which an X-ray is incident
Number of periods: 20, 21, and 22 (The order corresponds to the order in which the structural periods are described.)

(the present invention 2: thick dotted line)
Number of regions: 2
Structural period: 5.0 nm and 4.8 nm from the side on which an X-ray is incident
Number of periods: 20 and 21 (The order corresponds to the order in which the structural periods are described.)

(comparative example: solid line)
Number of regions: 1
Structural period: 5.0 nm
Number of periods: 20

The figure proves that the X-ray mirror functions as a mirror for X-rays having different energies, in particular, X-rays having continuous energies when the number of regions having different structural periods is set to multiple, in particular, the number of the regions is set to 3.

(5) Effect of Order in Which Multiple Regions Having Different Structural Periods are Placed

In this section, an effect of the order in which multiple regions having different structural periods of the mesostructured film that has the multiple regions in the normal direction of the substrate surface of the present invention are placed is shown.

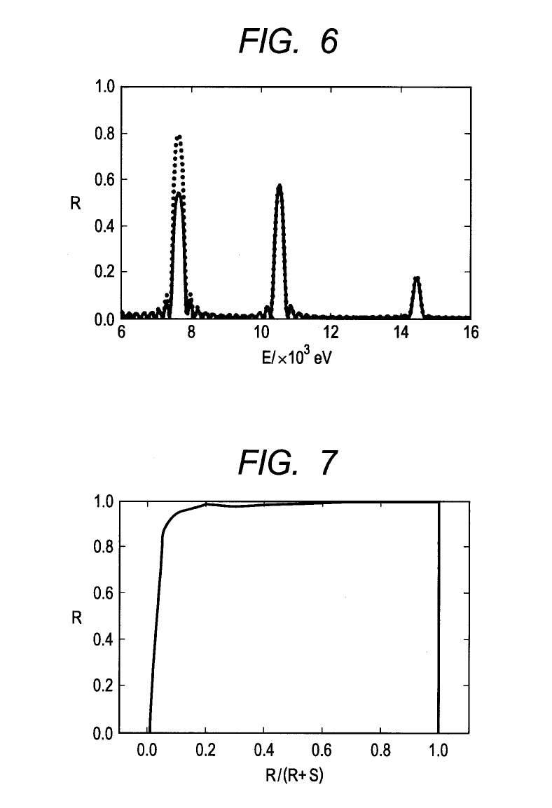

FIG. 6 illustrates a calculated value for the dependence of the reflectance of an X-ray mirror formed of a mesostructured film that has multiple regions having different structural periods (axis of ordinate) on the energy of an X-ray (axis of abscissa) under the following conditions.

(Common Conditions)
Number of regions: 3
Wall portion of mesostructured film: Silicon oxide (SiO₂)
Pore or organic compound site of mesostructured film: Surfactant (EO (20) PO (70) EO (20))
Incidence angle: 0.5°
Ratio (thickness) of pores or organic compound sites to mesostructured film: 0.7

(the present invention 1: dotted line)
Number of regions: 3
Structural period: 10 nm, 7 nm, and 4 nm from the side on which an X-ray is incident
Number of periods: 30, 43, and 75

(The order corresponds to the order in which the structural periods are described.)

(the present invention 2: solid line)
Number of regions: 3
Structural period: 4 nm, 7 nm, and 10 nm from the side on which an X-ray is incident
Number of periods: 75, 43, and 30

(The order corresponds to the order in which the structural periods are described.)

In the figure, the reflectance of the present invention 1 shows a large value as compared with that of the reflectance of the present invention 2 at around 7.6 keV. On the other hand, the reflectance of the present invention 2 shows a large value as compared with that of the reflectance of the present invention 1 at around 14.5 keV. Ratios ((smaller value)/(larger value)) between the reflectance at around 7.6 keV and 14.5 keV are 0.680 and 0.940, respectively. Simply judging at least from the ratios, the order of the present invention 1 that shows a high value at around 7.6 keV proves to be advantageous.

As illustrated in FIG. 2, the transmitting ability of an X-ray raises as its energy increases. Accordingly, the following order is effective. A structure having a long period (10 nm in this example) corresponding to a low energy is placed on a side close to a plane on which an X-ray is incident, and a structure having a short period (4 nm in this example) corresponding to a high energy is placed on a side distant from the plane.

(6) Effect of Material For Forming Wall Portion of Mesostructured Film

In this section, an effect of a material for forming a wall portion of the mesostructured film used in the X-ray mirror of the present invention is shown.

Table 2 shows a peak value determined when the dependence of the reflectance of an X-ray mirror formed of a mesostructured film having periodic structures in the normal direction of a substrate surface on an energy is calculated under the following conditions.

(Common Conditions)
Number of regions: 3
Pore or organic compound site of mesostructured film: Air pore (nitrogen)
Incidence angle: 0.5°
Ratio (thickness) of pores or organic compound sites to mesostructured film: 0.7
Structural period: 10 nm, 7 nm, and 4 nm from the side on which an X-ray is incident
Number of periods: 4 for each period
Energies of incident X-rays:5 to 24 keV

(the present invention 1)
Wall portion of mesostructured film: silicon oxide (SiO₂)

(the present invention 2)
Wall portion of mesostructured film: titanium oxide (TiO₂)

(the present invention 3)
Wall portion of mesostructured film: tin oxide (SnO₂)

TABLE 2

| | | | Peak value |
|---|---|---|---|
| | Material for wall | | of |
| X-ray mirror | portion | Density | reflectance |
| The present | Silicon oxide | 2.20 | 0.0426 |
| invention 1 | (SiO₂) | | |
| The present | Titanium oxide | 4.23 | 0.346 |
| invention 2 | (TiO₂) | | |
| The present | Tin oxide (SnO₂) | 7.31 | 0.458 |
| invention 3 | | | |

An interaction between a substance and an X-ray enlarges as the electron density of the substance increases. Of the substances used here, tin oxide shows a high reflectance because of its high density (substantially proportional to its electron density). When the number of periods is small like the condition of this example, a material for a wall portion of a mesostructured film largely affects a reflectance. In the case of such condition, it is effective to use a wall material having a high density.

(7) Effect of Ratio (Thickness) of Pores or Organic Compound Sites to Mesostructured Film

FIG. 7 illustrates a calculated value for the dependence of the peak value of the reflectance of an X-ray mirror formed of a mesostructured film having periodic structures in the normal direction of a substrate surface (axis of ordinate) on a ratio (thickness) of pores or organic compound sites to the mesostructured film (axis of abscissa) under the following conditions.

(Conditions)
Number of regions: 3
Structural period: 5.0 nm, 4.8 nm, and 4.6 nm from the side on which an X-ray is incident
Wall portion of mesostructured film: Silicon oxide (SiO₂)
Pore or organic compound site of mesostructured film: Air pore (nitrogen)
Energies of incident X-rays:8 to 24 keV
Number of periods: 5,000

The figure proves that the X-ray mirror shows a high reflectance when the ratio (thickness) of the pores or the organic compound sites to the mesostructured film is set to 0.012 or more and 0.997 or less.

(8) Method of Producing X-Ray Mirror

(8-1) described in this section is a method of producing a mesoporous silicon oxide having a two-dimensional hexagonal structure whose number of regions is three and which is prepared on a flat substrate.

(a) Preparation of Solution

A silicon oxide mesostructured film having a two-dimensional hexagonal structure is prepared by a dip coating method. A dip coating solution is prepared by dissolving a block polymer in an ethanol solvent and then adding thereto ethanol, water, hydrochloric acid, and tetraethoxysilane, followed by stirring at 70° C. for 1 hour. Methanol, propanol, 1,4-dioxane, tetrahydrofuran, or acetonitrile can be used instead of ethanol. A mixing ratio (molar ratio) “tetraethoxysilane:block polymer:water:hydrochloric acid:ethanol” is set to 1:0.001:8:0.01:40.

Used as the block polymer are EO (20) PO (30) EO (20), EO (26) PO (39) EO (26), and EO (20) PO (70) EO (20) for the first mesostructured film, the second mesostructured film, and the third mesostructured film, respectively.

(b) Formation of Film

A washed silicon substrate is subjected to dip coating with a dip coating apparatus at a lifting speed of 0.5 to 2 mms⁻¹. At this time, a temperature is 25° C. and a relative humidity is 40%. After having been formed, a film is held in a thermo-hygrostat at 25° C. and a relative humidity of 50% for 24 hours. When a region is laminated thereafter, the resultant is further held at 60° C. for 24 hours, at 130° C. for 24 hours, and at 200° C. for 2 hours before the second and third mesostructured films are each formed by the same step.

(c) Baking

After the first to third mesostructured films have been formed, the mesostructured films are baked in air at 400° C. for 10 hours so that the block polymers in the pores may be removed.

(d) Evaluation

The baked mesoporous film is subjected to X-ray diffraction analysis of Bragg-Brentano geometry. As a result, it is confirmed that the mesoporous film has high order in the normal direction of the substrate surface and its structural period is 7.8 nm, 8.8 nm, and 9.6 nm. Comparison with each single region formed from the same solution as that used for the formation of the corresponding one of the first to third mesostructured films confirms that the structural period of 7.8 nm corresponds to a first region, the structural period of 8.8 nm corresponds to a second region, and the structural period of 9.6 nm corresponds to a third region.

When white X-rays are made incident on the mesoporous silicon oxide at incidence angles of 0.5° each, such reflection of the X-rays of peaks at 9.2 keV, 8.1 keV, and 7.4 keV is observed. The foregoing shows that the mesoporous silicon oxide film of this example functions as a mirror corresponding to X-rays having different energies.

(8-2) described in this section is a method of producing a mesostructured film having a lamellar structure whose number of regions is four and which is prepared on a curved substrate.

(a) Preparation of Solution

A mesostructured film having a lamellar structure is prepared by a spin coating method. A precursor solution is prepared by dissolving n-decyltrimethoxysilane, tetramethoxysilane, water, and hydrochloric acid in a tetrahydrofuran solvent, and stirring the resultant at room temperature for a predetermined time. A mixing ratio (molar ratio) “n-decyltrimethoxysilane:tetramethoxysilane:water:hydrochl oric acid:tetrahydrofuran” is set to 1:4:19:0.01:20.

The stirring time is 6 hours for a first mesostructured film, 3 hours for a second mesostructured film, 1 hour for a third mesostructured film, and 0.5 hour for a fourth mesostructured film.

(b) Film Formation

After a convex lens substrate having a large radius of curvature has been washed, coating is performed with a spin coating apparatus under the conditions of 3,000 rpm and 10 seconds. At this time, a temperature is 25° C. and a relative humidity is 40%. After having been formed, the film is held in a thermo-hygrostat at 25° C. and a relative humidity of 50% for 4 weeks. When a region is laminated thereafter, an upper region is formed on the above-mentioned substrate by the same step.

(c) Evaluation

The mesostructured film is subjected to X-ray diffraction analysis of Bragg-Brentano geometry. As a result, it is confirmed that the mesostructured film has high order in the normal direction of the substrate surface and its structural period is 3.46 nm, 3.56 nm, 3.76 nm, and 3.88 nm. Comparison with each single region formed from the same solution as that used for the formation of the corresponding one of the first to fourth mesostructured films confirms that the structural period of 3.46 nm corresponds to a first region, the structural period of 3.56 nm corresponds to a second region, the structural period of 3.76 nm corresponds to a third region, and the structural period of 3.88 nm corresponds to a fourth region.

When X-rays of 8 keV are made incident on the mesoporous silicon oxide, such reflection of the X-rays of peaks at 1.28°, 1.25°, 1.18°, and 1.14° is observed. The foregoing shows that the mesostructured film of this example functions as an X-ray mirror that reflects X-rays having different angles.

(8-3) described in this section is a method of producing a mesostructured film having a total of three regions in which a titanium oxide mesostructured film having a three-dimensional cubic structure is formed on a film having two regions each formed of a silicon oxide mesostructure having a two-dimensional hexagonal structure prepared on a flat substrate.

(a) Production of Silicon Oxide Mesostructured Film

A silicon oxide mesostructured film having a two-dimensional hexagonal structure is prepared by means of the solution for each of the second mesostructured film and the third mesostructured film, and the approach which are described in the section (8-1).

(b) Preparation of Precursor Solution for Titanium Oxide Mesostructured Film

First, a block polymer is dissolved in an ethanol solvent, and then titanium(IV) chloride is added dropwise thereto. Water is further added and the whole is stirred. Thus the solution is prepared. A mixing ratio (molar ratio) “titanium(IV) chloride:block polymer:water:ethanol” is set to 1:0.005:10:40. Used as the block polymer is EO (106) PO (70) EO (106).

(c) Formation of Film

On the first and second mesostructured films each formed of silicon oxide prepared by using the condition described in the section (8-1), a film is formed by dip coating with a dip coating apparatus at a lifting speed of 0.5 to 2 mms⁻¹. At this time, a temperature is 25° C. and a relative humidity is 40%. After having been formed, the film is held in a thermo-hygrostat at 25° C. and a relative humidity of 50% for 2 weeks, and further held at 60° C., 100° C., and 130° C., each for 24 hours.

(d) Baking

After the first to third mesostructured films have been formed, the mesostructured films are baked in air at 400° C. for 10 hours so that the block polymers in the pores may be removed.

(e) Evaluation

The baked mesoporous film is subjected to X-ray diffraction analysis of Bragg-Brentano geometry. As a result, it is confirmed that the mesoporous film has high order in the normal direction of the substrate surface and its structural period is 8.8 nm, 9.6 nm, and 10.1 nm. Comparison with each single region formed from the same solution as that used for the formation of the corresponding one of the first to third mesostructured films confirms that the structural period of 8.8 nm corresponds to a first region, the structural period of 9.6 nm corresponds to a second region, and the structural period of 10.1 nm corresponds to a third region formed of titanium oxide.

When white X-rays are made incident on the mesostructured film at incidence angles of 0.5° each, such reflection of the X-rays of peaks at 8.1 keV, 7.4 keV, and 7.0 keV is observed. The foregoing shows that the mesostructured film of this example functions as a mirror corresponding to X-rays having different energies.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent

Application No. 2010-126325, filed Jun. 1, 2010, which is hereby incorporated by reference herein in its entirety.

1. An X-ray mirror, comprising:
a substrate; and
an X-ray reflecting structure formed of multiple regions present on the substrate,
wherein the X-ray reflecting structure comprises a mesostructured film that has the multiple regions having different structural periods in a normal direction of the substrate.

2. The X-ray mirror according to claim 1, wherein the multiple regions comprise three or more regions.

3. The X-ray mirror according to claim 1, wherein the multiple regions having the different structural periods are arranged to increase their structural period with increasing distance between the region and the substrate.

4. The X-ray mirror according to claim 1, wherein:
the multiple regions having the different structural periods each comprise a layer; and
the structural periods of the respective layers are different from each other.

5. The X-ray mirror according to claim 1, wherein the mesostructured film comprises a mesoporous film.

6. A method of producing an X-ray mirror including a substrate and an X-ray reflecting structure formed of multiple regions present on the substrate, the method comprising, as formation of the X-ray reflecting structure, at least:
forming a first mesostructured film having a periodic structure on the substrate; and
forming, on the first mesostructured film, a second mesostructured film having a periodic structure different from the first mesostructured film in structural period.

7. An X-ray apparatus including an X-ray optical path therein, the X-ray apparatus comprising the X-ray mirror according to claim 1 in the optical path.
